(19) United States
(12) Patent Application Publication
(10) Pub. No.: US 2020/0143821 A1
(43) Pub. Date: May 7, 2020

(54) PROTECTING SENSITIVE INFORMATION ON STORED AUDIO RECORDINGS

(71) Applicant: INTERNATIONAL BUSINESS MACHINES CORPORATION, Armonk, NY (US)

(72) Inventors: MORRIS S. JOHNSON, JR., CARY, NC (US); JOEL DUQUENE, RALEIGH, NC (US); ADRIENNE MILLER, DURHAM, NC (US); SHELTON M. JONES, II, DURHAM, NC (US)

(21) Appl. No.: 16/180,045

(22) Filed: Nov. 5, 2018

(51) Int. Cl. G10L 25/51; G06F 21/62; G10L 15/28; G10L 19/00; G10L 25/87

(52) U.S. Cl. CPC G10L 25/51; G06F 21/6245; G10L 2015/088; G10L 19/0019; G10L 25/87; G10L 15/28

(57) ABSTRACT

Examples of techniques for protecting sensitive information are disclosed. Aspects include receiving a request from a first user to listen to a recording and obtaining the recording the recording comprising an audio track and an identification of one or more participants in the audio track. Based on a determination that the first user is one of the one or more participants in the audio track, aspects include playing the audio track in an original format. Based on a determination that the first user is not one of the one or more participants in the audio track, aspects include playing the audio track in a modified format.

### BACKGROUND

The present invention generally relates to information security, and more specifically, to protecting sensitive information on stored audio recordings.

Whenever a consumer calls a business the call is answered and handled by a customer service representative in a call center. Often, at some point during the call, the consumer provides identifying information to the customer service representative. In addition, a customer may often provide their credit card and/or bank account information during the call when making payments. Many businesses record all telephone calls to protect both the consumer and the business from fraud as well as for training purposes for the business.

Currently, any individuals with access to a recording of a call can access the sensitive data provided by the consumer o the call by simply accessing the recorded call office. As a result, people other than the customer service representative can access and steal the sensitive information.

### SUMMARY

Embodiments of the present invention are directed to a computer-implemented method for protecting sensitive information stored on audio recordings. An example of the computer-implemented method includes receiving a request from a first user to listen to a recording and obtaining the recording the recording comprising an audio track and an identification of one or more participants in the audio track. Based on a determination that the first user is one of the one or more participants in the audio track, the method includes playing the audio track in an original format. Based on a determination that the first user is not one of the one or more participants in the audio track, the method includes playing the audio track in a modified format.

Embodiments of the present invention are directed to a computer program product for protecting sensitive information stored on audio recordings. The computer program product being on a computer readable storage medium having program instructions embodied therewith, the program instructions executable by a processing device to cause the processing device to perform a method. The method includes receiving a request from a first user to listen to a recording and obtaining the recording the recording comprising an audio track and an identification of one or more participants in the audio track. Based on a determination that the first user is one of the one or more participants in the audio track, the method includes playing the audio track in an original format. Based on a determination that the first user is not one of the one or more participants in the audio track, the method includes playing the audio track in a modified format.

Embodiments of the present invention are directed to a system for protecting sensitive information stored on audio recordings. The system includes a memory having computer readable instructions and a processing device for executing the computer readable instructions for performing a method. The method includes receiving a request from a first user to listen to a recording and obtaining the recording the recording comprising an audio track and an identification of one or more participants in the audio track. Based on a determination that the first user is one of the one or more participants in the audio track, the method includes playing the audio track in an original format. Based on a determination that the first user is not one of the one or more participants in the audio track, the method includes playing the audio track in a modified format.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to one or more embodiments described herein;

FIG. 2 depicts abstraction model layers according to one or more embodiments described herein;

FIG. 3 depicts a block diagram of a processing system for implementing the described techniques according to one or more embodiments described herein;

FIG. 4 depicts a block diagram of a customer service environment according to one or more embodiments described herein;

FIG. 5 depicts a flow diagram of a method for protecting sensitive information stored on audio recordings according to one or more embodiments described herein;

FIG. 6 depicts a flow diagram of a method for protecting sensitive information stored on audio recordings according to one or more embodiments described herein; and

FIG. 7 depicts a flow diagram of a method for protecting sensitive information stored on audio recordings according to one or more embodiments described herein.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that, although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

### Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems; storage, deployed applications, and possibly limited control of select networking components (e.g., host firewalls).

### Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

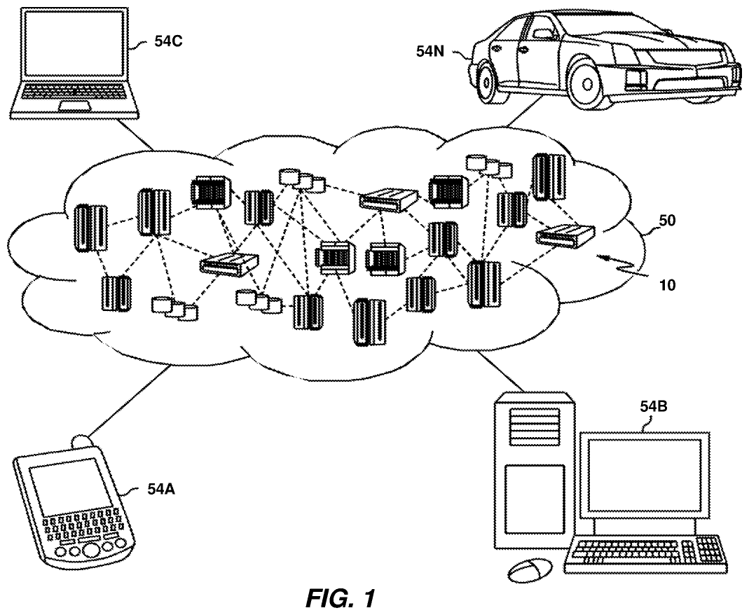

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

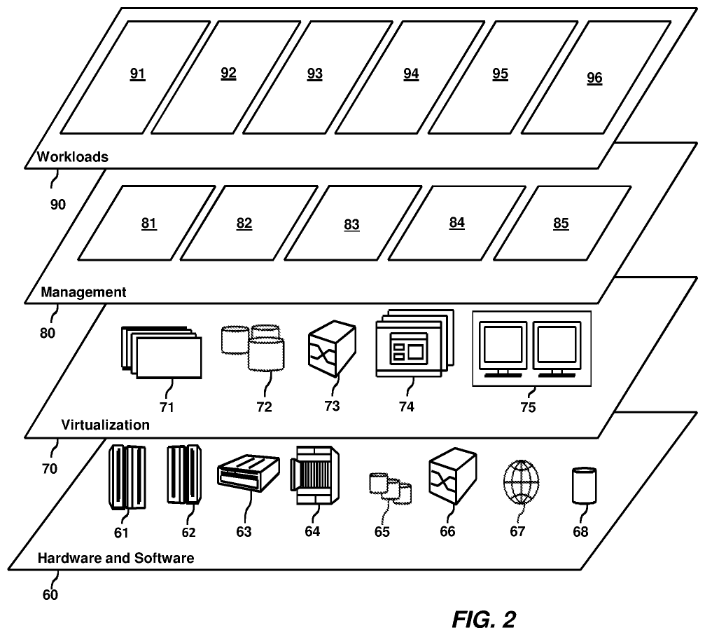

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and protecting sensitive information stored on audio recordings 96.

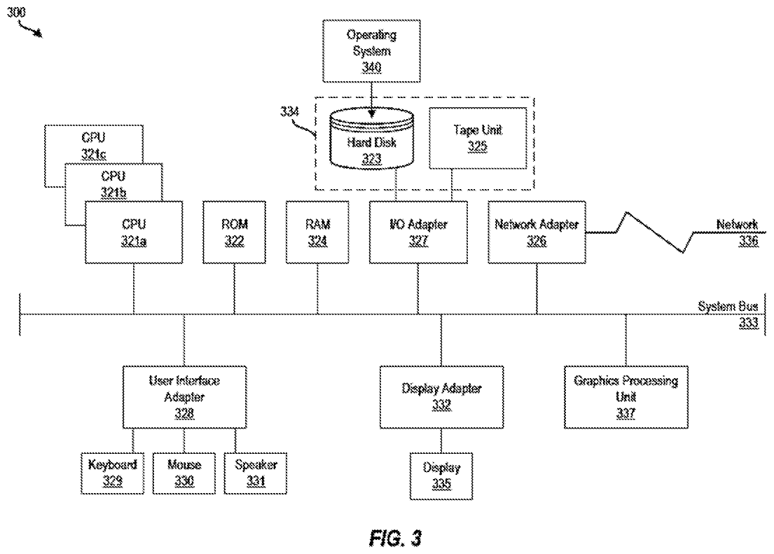

It is understood that the present disclosure is capable of being implemented in conjunction with any other type of computing environment now known or later developed. For example, FIG. 3 depicts a block diagram of a processing system 300 for implementing the techniques described herein. In examples, processing system 300 has one or more central processing units (processors) 321a, 321b, 321c, etc. (collectively or generically referred to as processor(s) 321 and/or as processing device(s)). In aspects of the present disclosure, each processor 321 can include a reduced instruction set computer (RISC) microprocessor. Processors 321 are coupled to system memory (e.g., random access memory (RAM) 324) and various other components via a system bus 333. Read only memory (ROM) 322 is coupled to system bus 333 and may include a basic input/output system (BIOS), which controls certain basic functions of processing system 300.

Further depicted are an input/output (I/O) adapter 327 and a network adapter 326 coupled to system bus 333. I/O adapter 327 may be a small computer system interface (SCSI) adapter that communicates with a hard disk 323 and/or a tape storage drive 325 or any other similar component. I/O adapter 327, hard disk 323, and tape storage device 325 are collectively referred to herein as mass storage 334. Operating system 340 for execution on processing system 300 may be stored in mass storage 334. The network adapter 326 interconnects system bus 333 with an outside network 336 enabling processing system 300 to communicate with other such systems.

A display (e.g., a display monitor) 335 is connected to system bus 333 by display adaptor 332, which may include a graphics adapter to improve the performance of graphics intensive applications and a video controller. In one aspect of the present disclosure, adapters 326, 327, and/or 232 may be connected to one or more I/O busses that are connected to system bus 333 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 333 via user interface adapter 328 and display adapter 332. A keyboard 329, mouse 330, and speaker 331 may be interconnected to system bus 333 via user interface adapter 328, which may include, for example, a Super I/O chip integrating multiple device adapters into a single integrated circuit.

In some aspects of the present disclosure, processing system 300 includes a graphics processing unit 337. Graphics processing unit 337 is a specialized electronic circuit designed to manipulate and alter memory to accelerate the creation of images in a frame buffer intended for output to a display. In general, graphics processing unit 337 is very efficient at manipulating computer graphics and image processing, and has a highly parallel structure that makes it more effective than general-purpose CPUs for algorithms where processing of large blocks of data is done in parallel.

Thus, as configured herein, processing system 300 includes processing capability in the form of processors 321, storage capability including system memory (e.g., RAM 324), and mass storage 334, input means such as keyboard 329 and mouse 330, and output capability including speaker 331 and display 335. In some aspects of the present disclosure, a portion of system memory (e.g., RAM 324) and mass storage 334 collectively store an operating system such as the AIX® operating system from IBM Corporation to coordinate the functions of the various components shown in processing system 300.

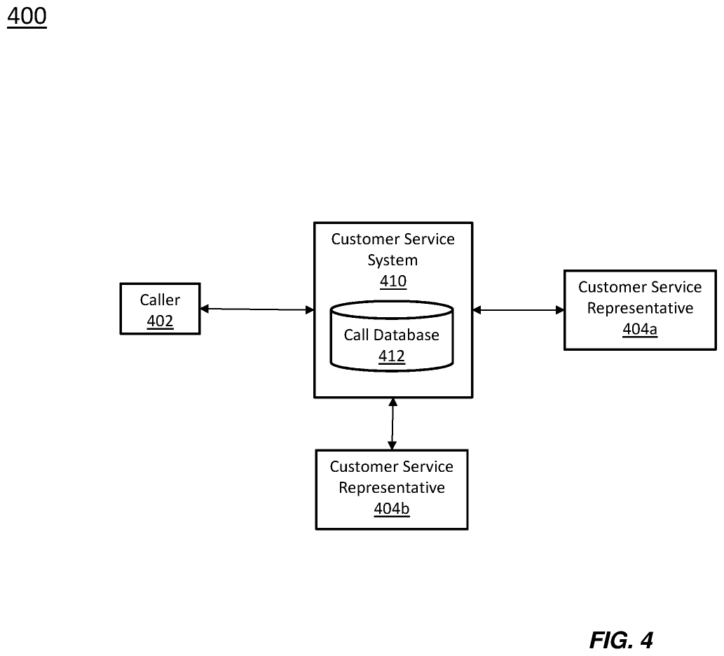

Turning now to a more detailed description of aspects of the present invention, FIG. 4 depicts a block diagram of a customer service environment 400 according to one or more embodiments described herein. The customer service environment 400 includes a customer service system 410 that is configured to connect a caller 402 to a customer service representative 404. In exemplary embodiments, the customer service system 410 is configured to record all calls between callers 402 and a customer service representative 404 in a call database 412. In exemplary embodiments, the customer service system 410 can be embodied in a processing system such as the one shown in FIG. 3 or in a cloud-based system such as the one shown in FIGS. 1 and 2.

In exemplary embodiments, the customer service system 410 is configured to analyze the audio of a recorded call to identify sensitive information that is provided by the caller 402 during the call. This analysis can be done in a variety of ways and can be used to identify account numbers, social security numbers, credit card or banking information, email addresses, passwords and/or answers to challenge questions. In one embodiment, the customer service system 410 is configured to store two versions of a recorded call, an original version, and a modified or masked version. The modified or masked version is a version of the recording in which the customer service system 410 has modified the audio recording to obfuscate the sensitive information provided by the caller 402. The obfuscation can include deleting that portion of the recording, it can include playing a tone or other noise over the audio track or scrambling the portion of the audio track to make the sensitive information unintelligible.

In exemplary embodiments, the customer service system 410 is configured to store an indication of an identity of a customer service representative 404 that participated in a stored call in the call database 412. In addition, the customer service system 410 is configured to store an indication of what portion of a stored call the customer service representative 404 participated in. Often during customer service calls, more than one customer service representative 404 may speak to a caller 402, the call database 412 is configured to store one or more copies of a recording of the call along with an identification of which customer service representatives 404 participated in the stored call and the timestamps that indicate when each customer service representative 404 joined and left the call.

In exemplary embodiments, the customer service system 410 is configured to determine an identity of an individual attempting to access a stored recording from the call database 412 and to responsively provide an original or modified version of the recorded call based on the identity of the individual. In exemplary embodiments, various methods can be used to determine the identity of the individual attempting to access a stored recording. The methods can include verifying a username and password provided by the individual. In one embodiment, dual factor authentication can be used to determine the identity of the individual attempting to access a stored recording.

In exemplary embodiments, the customer service system 410 is configured to assign a trusted token to each customer service representative 404a, 404b. These trusted tokens are also associated with the recording that the customer service representative 404 participates on and are used by the customer service system 410 to control access to the original version of the recorded call.

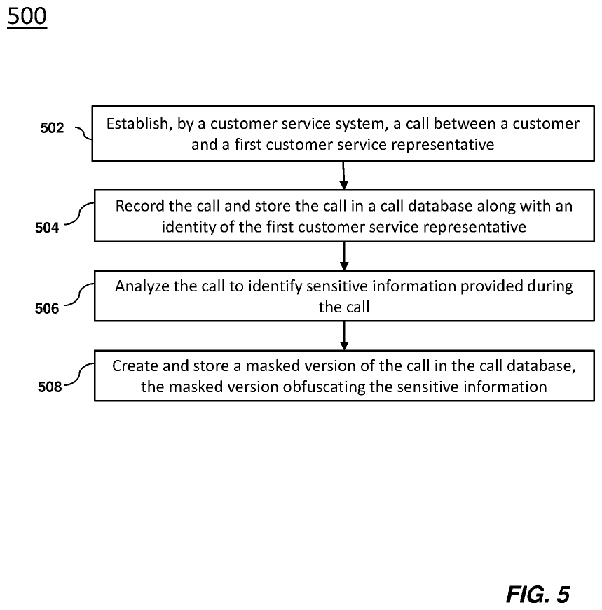

Referring now to FIG. 5, a flow diagram of a method 500 for protecting sensitive information stored on audio recordings according to one or more embodiments described herein is shown. The method 500 can be performed using any suitable processing system or device, such as the processing system 300, customer service system 410, and/or other suitable systems and/or devices. As shown at block 502, the method 500 includes establishing, by a customer service system, a call between a customer and a first customer service representative. Next, as shown at block 504, the method 500 includes record the call and storing the call in a call database along with an identity of the first customer service representative. In exemplary embodiments, the identification of first customer service representative is stored along with timestamps indicating when the first customer service representative joined and left the call. Next, as shown at block 506, the method 500 includes analyzing the call to identify sensitive information provided during the call. The sensitive information can include one or more of an account number, a password, a passcode, a birthdate, a phone number, and a social security number provided during the call. Next, as shown at block 506, the method 500 includes creating and storing a masked version of the call in the call database, wherein the masked version obfuscating the sensitive information. In another embodiment, a mask is created and stored along with the original stored call. The stored mask is selectively applied to the original call when it accessed to provide either the original call audio or a masked version of the call audio.

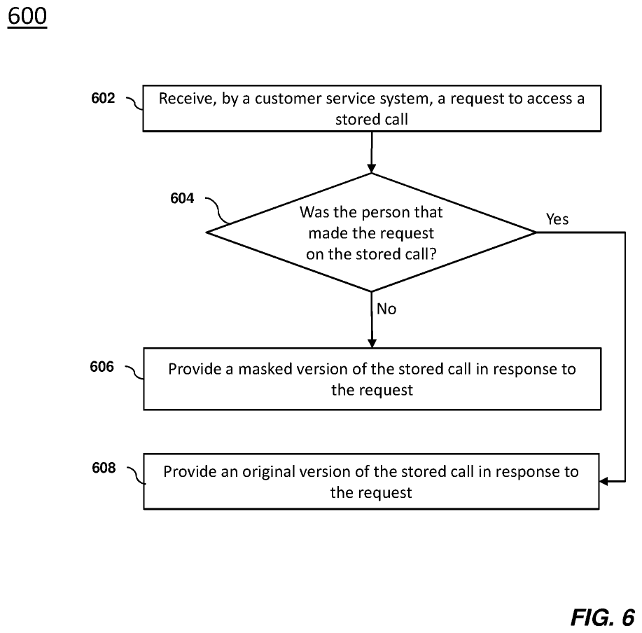

Referring now to FIG. 6, a flow diagram of a method 600 for protecting sensitive information stored on audio recordings according to one or more embodiments described herein is shown. The method 600 can be performed using any suitable processing system or device, such as the processing system 300, customer service system 410, and/or other suitable systems and/or devices. As shown at block 602, the method 600 includes receiving, by a customer service system, a request to access a stored call. Next, as shown at decision block 604, the method 600 includes determining if the person that made the request was a participant on the stored call. If the person that made the request was a participant on the stored call, the method 600 proceeds to block 606 and includes providing an original version of the stored call in response to the request. If the person that made the request was not a participant on the stored call, the method 600 proceeds to block 608 and includes providing a masked version of the stored call in response to the request, where the masked version of the call has sensitive data provided in the call obfuscated.

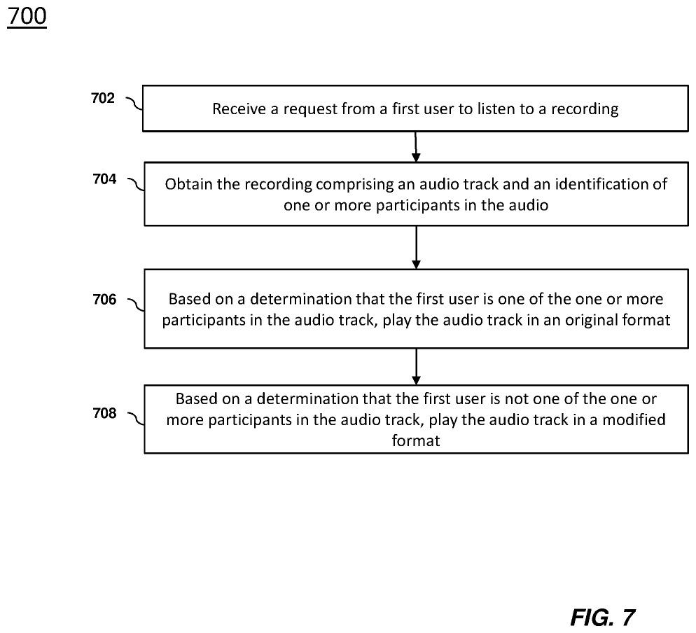

Referring now to FIG. 7, a flow diagram of a method 700 for protecting sensitive information stored on audio recordings according to one or more embodiments described herein is shown. The method 700 can be performed using any suitable processing system or device, such as the processing system 300, customer service system 410, and/or other suitable systems and/or devices. As shown at block 702, the method 700 includes receiving a request from a first user to listen to a recording. Next, as shown at block 704, the method 700 includes obtaining the recording, where the recording includes an audio track and an identification of one or more participants in the audio track. In exemplary embodiments, the identification of one or more participants in the audio track further includes a timestamp during which each of the one or more participants in the audio track joined and left the audio track. Next, as shown at block 706, the method 700 includes playing the audio track in an original format based on a determination that the first user is one of the one or more participants in the audio track. In exemplary embodiments, the determination of whether the first user is one of the one or more participants in the audio track is based at least in part on a voice recognition match between the first user and one of the one or more participants in the audio track.

Continuing with reference to FIG. 7, the method 700 also includes playing the audio track in a modified format based on a determination that the first user is not one of the one or more participants in the audio track. The modified format includes an obfuscation of at least a portion of the audio track. In an exemplary embodiment, based on the determination that the first user is not one of the one or more participants in the audio track, the method 700 further includes identifying one or more sensitive portions of the audio track and removing the identifying one or more sensitive portions of the audio track to create the modified format. In one embodiment, identifying one or more sensitive portions of the audio track includes identifying one or more of an account number, a password, a passcode, a birthdate, a phone number, and a social security number provided by the one or more participants in the audio track.

It should be understood that the process depicted in FIGS. 5, 6 and 7 represent illustrations, and that other processes may be added or existing processes may be removed, modified, or rearranged without departing from the scope and spirit of the present disclosure.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for protecting sensitive information, the method comprising:
receiving a request from a first user to listen to a recording;
obtaining the recording the recording comprising an audio track and an identification of one or more participants in the audio track;
based on a determination that the first user is one of the one or more participants in the audio track, playing the audio track in an original format; and
based on a determination that the first user is not one of the one or more participants in the audio track, playing the audio track in a modified format.

2. The method of claim 1, wherein the modified format includes an obfuscation of at least a portion of the audio track.

3. The method of claim 1, wherein the determination that the first user is not one of the one or more participants in the audio track, the method further includes identifying one or more sensitive portions of the audio track and removing the identifying one or more sensitive portions of the audio track to create the modified format.

4. The method of claim 3, wherein identifying one or more sensitive portions of the audio track includes identifying one or more of an account number, a password, a passcode, a birthdate, a phone number, and a social security number provided by the one or more participants in the audio track.

5. The method of claim 1, wherein the identification of one or more participants in the audio track further includes a timestamp during which each of the one or more participants in the audio track joined and left the audio track.

6. The method of claim 1, wherein the determination that the first user is one of the one or more participants in the audio track is based at least in part on a voice recognition match between the first user and one of the one or more participants in the audio track.

7. The method of claim 6, wherein based on the determination that the first user is one of the one or more participants in the audio track, the method further comprises performing a dual factor identity verification of the first user prior to playing the audio track in the original format.

8. A system comprising:
a memory comprising computer readable instructions; and
a processing device for executing the computer readable instructions for performing a method comprising:
receiving a request from a first user to listen to a recording;
obtaining the recording the recording comprising an audio track and an identification of one or more participants in the audio track;
based on a determination that the first user is one of the one or more participants in the audio track, playing the audio track in an original format; and
based on a determination that the first user is not one of the one or more participants in the audio track, playing the audio track in a modified format.

9. The system of claim 8, wherein the modified format includes an obfuscation of at least a portion of the audio track.

10. The system of claim 8, wherein the determination that the first user is not one of the one or more participants in the audio track, the method further includes identifying one or more sensitive portions of the audio track and removing the identifying one or more sensitive portions of the audio track to create the modified format.

11. The system of claim 10, wherein identifying one or more sensitive portions of the audio track includes identifying one or more of an account number, a password, a passcode, a birthdate, a phone number, and a social security number provided by the one or more participants in the audio track.

12. The system of claim 8, wherein the identification of one or more participants in the audio track further includes a timestamp during which each of the one or more participants in the audio track joined and left the audio track.

13. The system of claim 8, wherein the determination that the first user is one of the one or more participants in the audio track is based at least in part on a voice recognition match between the first user and one of the one or more participants in the audio track.

14. The system of claim 13, wherein based on the determination that the first user is one of the one or more participants in the audio track, the method further comprises performing a dual factor identity verification of the first user prior to playing the audio track in the original format.

15. A computer program product comprising:
a computer readable storage medium having program instructions embodied therewith, the program instructions executable by a processing device to cause the processing device to perform a method for enhanced teleconferencing, the method comprising:
receiving a request from a first user to listen to a recording;
obtaining the recording the recording comprising an audio track and an identification of one or more participants in the audio track;
based on a determination that the first user is one of the one or more participants in the audio track, playing the audio track in an original format; and
based on a determination that the first user is not one of the one or more participants in the audio track, playing the audio track in a modified format.

16. The computer program product of claim 15, wherein the modified format includes an obfuscation of at least a portion of the audio track.

17. The computer program product of claim 15, wherein the determination that the first user is not one of the one or more participants in the audio track, the method further includes identifying one or more sensitive portions of the audio track and removing the identifying one or more sensitive portions of the audio track to create the modified format.

18. The computer program product of claim 17, wherein identifying one or more sensitive portions of the audio track includes identifying one or more of an account number, a password, a passcode, a birthdate, a phone number, and a social security number provided by the one or more participants in the audio track.

19. The computer program product of claim 15, wherein the identification of one or more participants in the audio track further includes a timestamp during which each of the one or more participants in the audio track joined and left the audio track.

20. The computer program product of claim 15, wherein the determination that the first user is one of the one or more participants in the audio track is based at least in part on a voice recognition match between the first user and one of the one or more participants in the audio track.
